(19) United States
(12) Patent Application Publication
(10) Pub. No.: US 2017/0308817 A1
(43) Pub. Date: Oct. 26, 2017

(54) APPARATUS AND METHOD TO RESERVE, LOCATE AND OPERATE A VEHICLE FROM AN ON-DEMAND VEHICLE SERVICE

(71) Applicant: Ford Global Technologies, LLC, Dearborn, MI (US)

(72) Inventors: Thomas Lee MILLER, Ann Arbor, MI (US); Eric L. REED, Livonia, MI (US); Brian BENNIE, Sterling Heights, MI (US); Jacob LUCERO, Dearborn Heights, MI (US); Cameron SMYTH, Wyandotte, MI (US)

(21) Appl. No.: 15/134,535

(22) Filed: Apr. 21, 2016

(51) Int. Cl. G06Q 10/02; H04W 4/00

(52) U.S. Cl. CPC G06Q 10/02; H04W 4/008

(57) ABSTRACT

In at least one embodiment, an apparatus for reserving and accessing a vehicle is provided. The apparatus includes a transceiver and a controller. The controller is positioned in the vehicle and is configured to receive a first signal indicative of a reservation time for a user to gain access of the vehicle from a vehicle share server. The controller is further configured to activate the transceiver at a predetermined time prior to the reservation time to monitor for the presence of a mobile device.

### TECHNICAL FIELD

Aspects disclosed herein generally relate to an apparatus and method to reserve, locate and operate a vehicle from an on-demand vehicle service.

### BACKGROUND

U. S. Publication No. 2011/0060480 to Mottla discloses, but not limited to, methods, systems, and devices for reserving a reservable asset using a mobile device. A mobile device communicates directly with a vehicle-associated control module or through a reservation server using either a TCP/IP communications channel or near-field communications. A member enters a request using the user interface provided by the mobile-device application. The identity of the member is validated the vehicle-associated control module executes the request by sending a signal to a computer or sensor in the vehicle through the vehicle wiring or the vehicle CAN bus. The request can be a function, such as unlocking the vehicle doors, illuminating the interior or exterior lights, honking the horn, or activating a panic alarm.

### SUMMARY

In one embodiment, an apparatus for reserving and accessing a vehicle is provided. The apparatus includes a transceiver and a controller. The controller is positioned in the vehicle and is configured to receive a first signal indicative of a reservation time for a user to gain access of the vehicle from a vehicle share server. The controller is further configured to activate the transceiver at a predetermined time prior to the reservation time to monitor for the presence of a mobile device.

In another embodiment, an apparatus for reserving and accessing a vehicle is provided. The apparatus includes a Bluetooth Low Energy (BLE) transceiver and a controller. The controller is positioned in the vehicle and is configured to receive a first signal indicative of a reservation time for a user to gain access of the vehicle from a vehicle share server. The controller is further configured to activate the BLE transceiver at a predetermined time prior to the reservation time to monitor for the presence of a mobile device.

In another embodiment, a computer-program product embodied in a non-transitory computer readable medium that is programmed to reserve and access a vehicle is provided. The computer-program product includes instructions to transmit a first signal indicative of a reservation time for a user to gain access to a vehicle to a vehicle share server. The computer-program product further includes instructions to determine, via GPS coordinates, whether the user is approaching the vehicle at a first predetermined time prior to the reservation time to gain access to the vehicle.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 illustrates one example of a system that reserves, locates and operates a vehicle from an on-demand vehicle service in accordance to one embodiment; and

FIGS. 2A-2B illustrate one example of a first method and a second method, respectively, that reserves, locates and operates a vehicle from an on-demand vehicle service in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present disclosure generally provide for a plurality of circuits, electrical devices, and at least one controller. All references to the circuits, the at least one controller, and other electrical devices and the functionality provided by each, are not intended to be limited to encompassing only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

It is recognized that any controller (or head unit) as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any controller as disclosed, utilizes any one or more microprocessors to execute a computer-program that is embodied in a non-transitory computer readable medium that is programmed to perform any number of the functions as disclosed. Further, any controller as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware based inputs and outputs for receiving and transmitting data, respectively from and to other hardware based devices as discussed herein.

On-Demand Car Services are becoming more and more popular as an alternative to the traditional car rental businesses and personal car ownership in today's society. On-Demand Car Services are more convenient than the traditional car rental scheme in that the customer can use a mobile application (or app) to remotely reserve a vehicle in increments of hours, days or weeks. To further enhance the service, the vehicles are strategically located throughout a service area (e.g. neighborhoods, cities, airports, and college campus).

In order to use the service, the customer is required to first register with the service provider for approval. Once approved, the customer will receive a membership card that will enable the customer to use the service. Upon receiving the membership card, the customer can book a vehicle via an online portal or via a mobile app. When the customer books a vehicle, the customer is given the following information to help them locate the vehicle: a picture of the vehicle, a vehicle name, and a street address where the vehicle is located.

The customer must then navigate to the street address where the vehicle is located. Once there, the customer has to search an area (e.g., parking lot) for a vehicle that matches the picture provided to them and then find the one with a name tag that matches the name given to them in the reservation. Next, the customer uses their membership card to unlock the vehicle by holding the card over a wireless reader mounted on a windshield of the vehicle. Once in the vehicle, the customer will find an ignition key tethered to a retractable strap on the dashboard that is used to operate the vehicle. At the end of the reservation, the customer simply returns the vehicle to the same spot. While the above noted on-demand car service has positive aspects associated therewith, there may be problematic aspects of the experience.

For example, locating the vehicle may be difficult. Specifically, utilizing a “vehicle name” on the mobile app to a sticker on the vehicle is unnecessarily cumbersome. In some cases, the sticker on the vehicle with the “vehicle name” is not easily identifiable considering the vehicle is located in a parking lot with several vehicles of which that are more than likely identical in terms of makes & model to the vehicle being located. It is not unreasonable to assume that the customer may have to spend a significant amount of effort walking through the parking spot browsing name tags before finding the reserved vehicle.

Another drawback with the above noted on-demand car service is that a physical membership card is required. For example, the on-demand car service requires the service provider to produce and issue a membership card for all registered users. This is not an efficient process and such a process can be enhanced to improve the customer experience. Other issues that surround the physical membership card is that (i) there is a cost associated with producing and distributing the cards, (ii) the customer can either loss their card or simply forget their card, and/or (iii) the customer could lock the card in the vehicle.

Finally, with the on-demand car service, a battery in the car may exhibit battery drain. For example, the auxiliary telematics equipment located in the vehicle may compromise a high key off load strategy of the electrical system of the vehicle thereby resulting in a dead battery.

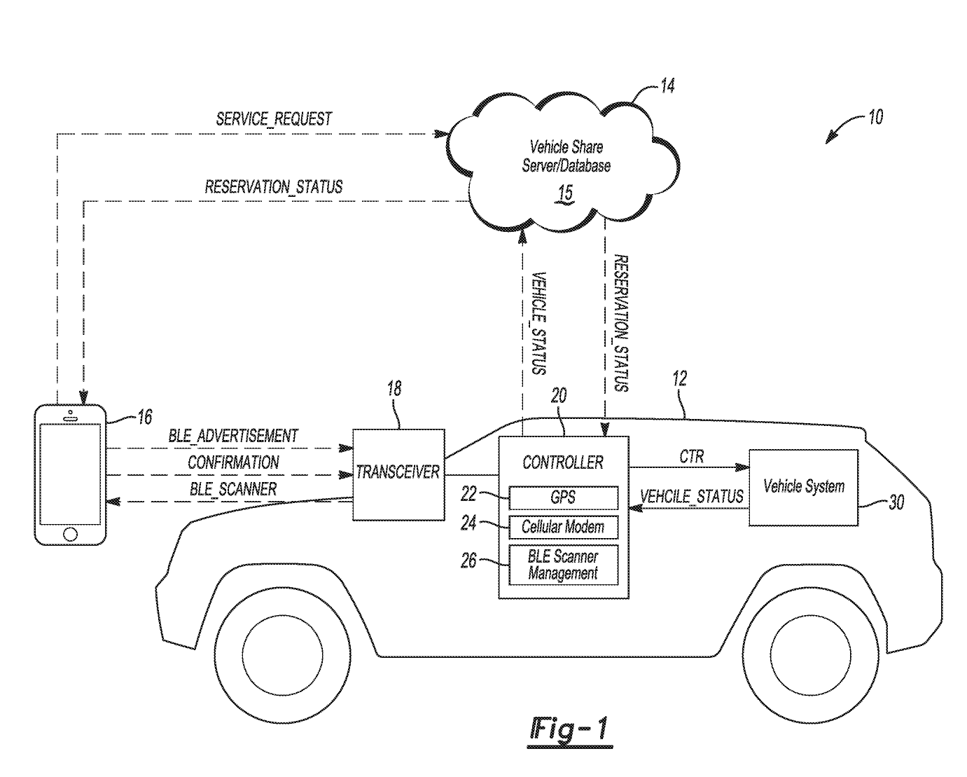

FIG. 1 illustrates one example of a system 10 that reserves, locates and operates a vehicle 12 from an on-demand vehicle service in accordance to one embodiment. The system 10 includes a vehicle share electronic server 14 (or vehicle share server) and/or database 15. The system 10 further includes a mobile device 16 that each engages in bi-directional wireless communication with the vehicle 12 to facilitate reserving, location, and operating the vehicle 12 in a vehicle share format (i.e., on-demand car service). The server 14 and/or database 15 are affiliated with the on-demand car service and the server 14 may engage in bi-directional communication with the vehicle 12. The database 15 stores relevant reservation information corresponding to the vehicle 12 that is to be rented for the on-demand car service and the customer who seeks rent the vehicle 12 of the on-demand car service.

A customer may book, or establish a reservation for the car service with the mobile 16. It is recognized that the mobile device 16 may be a cell phone, tablet, laptop, etc. The reservation may be made to reserve the vehicle 12 at any predetermined date and/or time. The server 14 receives information corresponding to the reservation (e.g., customer name, date/time of reservation, duration of the vehicle share, payment information, vehicle information (make, model, year, etc.) on a signal SERVICE_REQUEST and stores such information in the database 15. The server 14 may then wirelessly transmit the reservation (or schedule) information on a signal RESERVATION_STATUS to the vehicle 12 and the mobile device 16.

The vehicle 12 generally includes at least one transceiver 18 (hereafter “transceiver”) that is positioned in or on the vehicle 12. The mobile device 16 and the transceiver 18 wirelessly communicate with one another via Bluetooth Low Energy (BLE) (or within a BLE environment). An integrated telematics control unit 20 or vehicle controller 20 (hereafter “controller 20”) is positioned in the vehicle 12 and is operably coupled to the transceiver 18 for communicating with the mobile device 16. It is recognized that the functionality performed by the controller 20 may be separated and performed by any number of controllers positioned in the vehicle 12. The mobile device 16 and the controller 20 (e.g., via the transceiver 18) can communicate with one another within the BLE environment without the need for being previously paired and/or electrically mated with one another.

The mobile device 16 may be defined as an advertiser in the BLE environment and transmit a signal BLE_ADVERTISEMENT to the transceiver 18. In general, the signal BLE_ADVERTISEMENT may be recognized to be rather generic in that the signal may include simple data such as an identification or customer ID and/or a manufacturer specific data of the mobile device 16. The controller 20 utilizes the signal BLE_ADVERTISEMENT to identify a customer that seeks to use the vehicle 12 for the on-demand car service. The controller 20 along with the transceiver 18 may be defined as a scanner within the BLE environment. At the time of the reservation for the car service to occur, the controller 20 activates the transceiver 18 to scan for the signal BLE_ADVERTISEMENT from the mobile device 16 so that the vehicle 10 monitors for the presence of the customer via the customer's mobile device 16. The cellular modem 24 on the vehicle 12 enables WIFI access with the mobile device 16 and/or with the server 14. The vehicle 12 may engage in the bi-directional communication with the server 14 a transceiver (not shown) (e.g., 802.n transceiver or other suitable alternative).

The controller 20 includes a global positioning system (GPS) unit 22, a cellular modem 24, a BLE scanner management module 26, and a BLE location module 28. The controller 20 includes any number of microprocessors and memory for executing instructions or code associated with the BLE scanner management module 26 and the BLE location module 28. The GPS unit 22 provides GPS data (or location data) corresponding to the location of the vehicle 12. The BLE scanner management module 26 interfaces with the transceiver 18 to transmit a signal BLE_SCANNER to the mobile device 16 to initiate a BLUETOOTH pair and connect process. The mobile device 16 acknowledges the signal BLE_SCANNER and transmits a confirmation number on a signal CONFIRMATION.

The controller 20 receives the confirmation number and completes the BLUETOOTH pair and connect process. At this point, the vehicle 12 recognizes the mobile device 16 as a trusted device and the mobile device 16 may control various aspects of a vehicle system 30. For example, the controller 20 may transmit control signal(s) on a signal CTR to a vehicle system 30 that correspond to unlock, lock, engine start, etc. to the vehicle system 30. The vehicle system 30 may unlock one or more doors and/or a liftgate, start the engine, etc. The vehicle system 30 may then transmit a signal VEHICLE STATUS which indicates status such as the door being locked and unlocked or whether the engine of the vehicle has been started. The vehicle 12 may transmit information corresponding to the data on the VEHICLE_STATUS to the server 14 and/or database 15 to communicate that the vehicle 12 has been secured by the customer for the vehicle share. In general, it is recognized that the utilization of the components which comprise the BLE environment eliminates the need for a vehicle tag, customer membership, and/or a card reader.

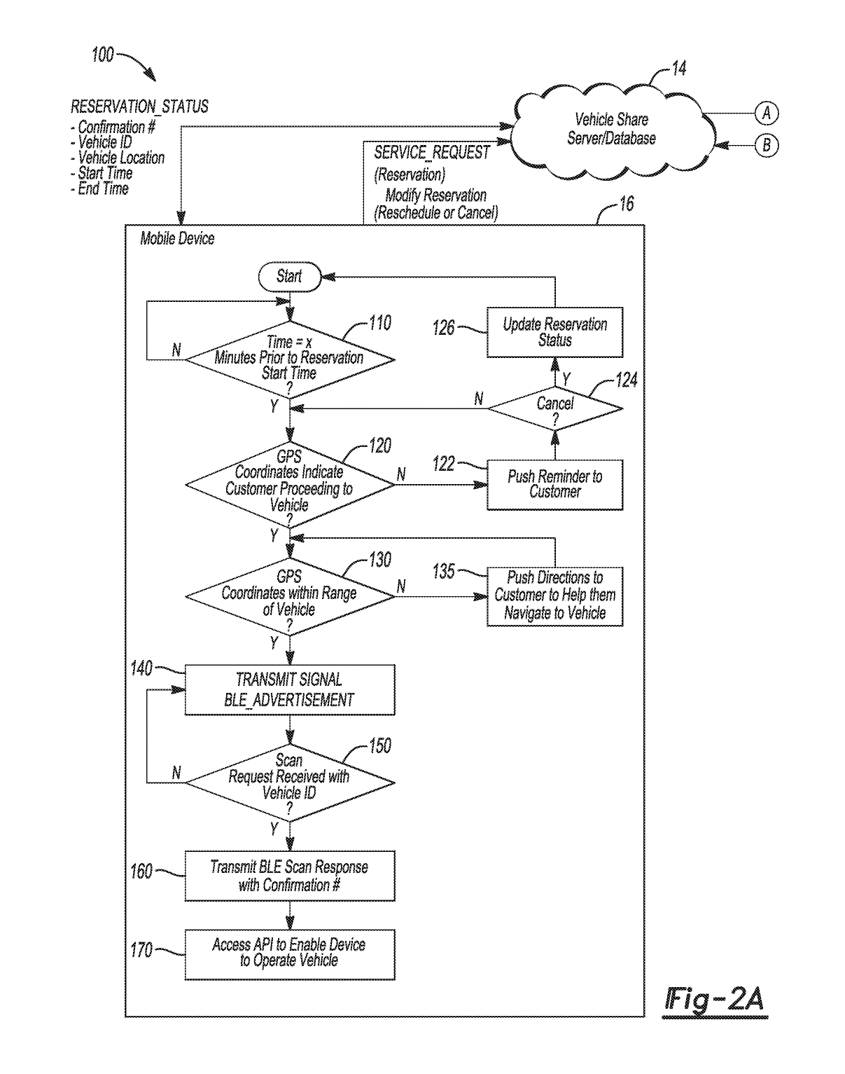

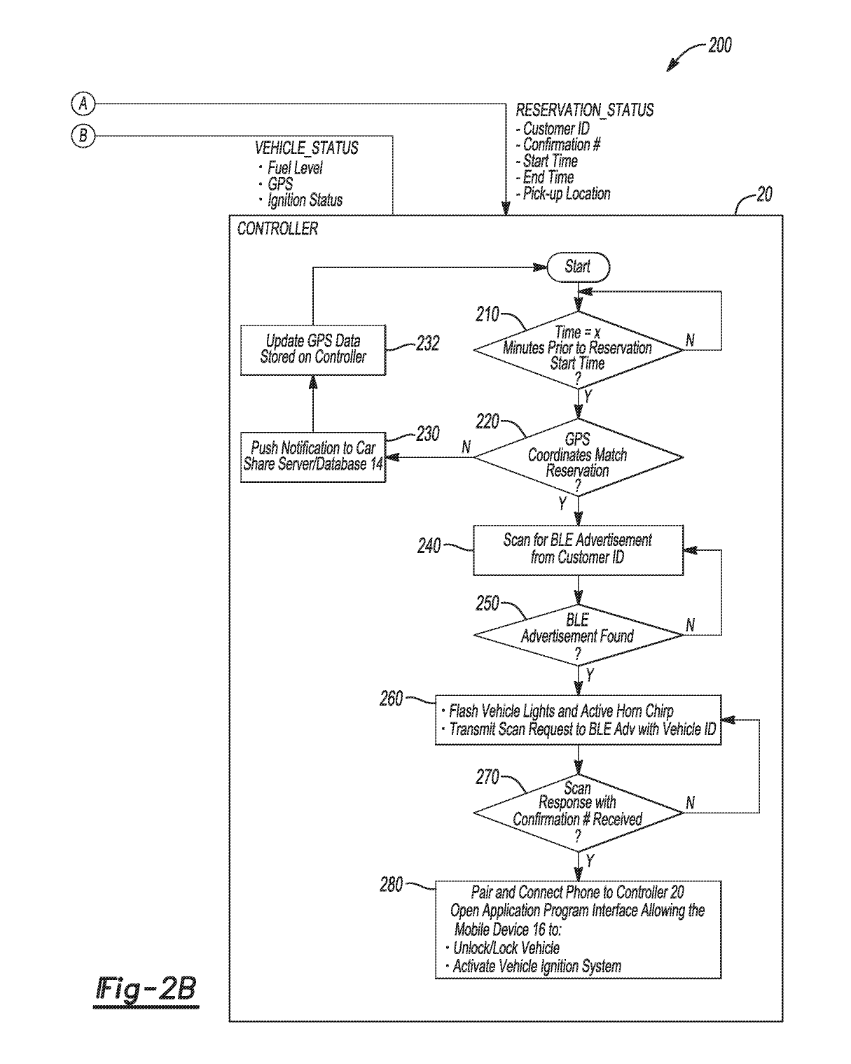

FIGS. 2A and 2B illustrate one example of a first method 100 and a second method 200, respectively, that reserves, locates and operates the vehicle 12 from an on-demand vehicle service in accordance to one embodiment.

The mobile device 16 is generally configured to execute the operations noted below in connection with the first method 100. In general, the customer will make a reservation using their respective mobile device 16 (e.g., see signal SERVICE_REQUEST). The server 14 provides a signal RESERVATION_STATUS to the mobile device 16 and to the vehicle 12 after receiving the reservation for the on-demand vehicle service, The signal RESERVATION_STATUS provides information corresponding but not limited to, a customer ID, a confirmation no. for the reservation, a vehicle ID (i.e., including the type of vehicle reserved), a location of the vehicle 12, a start time for the customer to begin the rental of the vehicle 12, and an end time for the rental of the vehicle 12 to expire. The controller 20 receives such information from the server 14 and transmits the most recent GPS data of the vehicle 12 to the server 14. The controller 20 activates the transceiver 18 to scan for BLE advertisement(s) on a signal BLE_ADVERTISEMENT from the mobile device 16 at a predetermined time before the reservation is active. This condition enables the mobile device 16 to reduce battery consumption as the transceiver 18 is active only at the time in which the reservation is imminent. Once the reservation is made, the mobile device 16 determines whether the customer is making their way to the vehicle 12 within a reasonable amount of time prior to the reservation. These aspects and more will be discussed in more detail below.

In operation 110, the mobile device 16 establishes a first time duration that corresponds to a period of time prior to the scheduled reservation start time to monitor for the location of the customer with respect to the location of the vehicle 12. Once the mobile device 16 has established the first time duration prior to the scheduled reservation start time, the mobile device 16 determines whether a current time falls with the first time duration of the scheduled reservation time to monitor for the location of the customer with respect to the location of the vehicle 12. This condition enables the mobile device 16 to preserve power consumption since the mobile device 16 monitors for the location of the customer with respect to the vehicle 12 for a relatively smaller duration of time versus monitoring for the location of the customer with respect to the vehicle 12 when the reservation is first made as it is possible that the reservation may be made hours before the start of the reservation. It would not be ideal for the mobile device 16 to monitor the location of the customer with respect to the location of the vehicle 12 for a long period of time prior to the reservation of the car service as this condition may drain the battery of the mobile device 16. In one example, the first time duration may be one hour before the scheduled reservation time to start to monitor the location of the customer in relation to the location of the vehicle 12. If the current time is not within the first time duration, then the method 100 stays in operation 110. If the current time is within the first time duration, then the method 100 moves to operation 120.

In operation 120, the mobile device 16 determines whether the customer is proceeding in a direction toward the location of the vehicle 12. For example, the mobile device 16 determines whether its GPS coordinates are heading in a direction toward the location of the vehicle 12. If this condition is true, then the method 100 proceeds to operation 130. If this condition is false, then the method 100 proceeds to operation 122.

In operation 122, the mobile device 16 provides a visual and/or audible notification to the customer that the customer is not heading in a direction to where the vehicle 12 is located. The mobile device 16 may also provide a prompt (or quick access menu) to enable the customer to cancel or change the reservation time in the event the customer cannot meet the originally scheduled reservation time.

In operation 124, the mobile device 16 determines whether the customer has changed or canceled the originally scheduled reservation time. If this condition is true, then the method 100 proceeds to operation 126 and the mobile device 16 transmits a modified reservation to the server 14. If this condition is not true, then the method proceeds back to operation 120.

In operation 130, the mobile device 16 determines whether the customer is within a predetermined distance of the vehicle 12. Specifically, the predetermined distance may correspond to the allotted distance within the BLE environment to enable to the vehicle 12 to detect the presence of the mobile device 16. In one example, the predetermined distance may be less than or equal to 100 meters. If this condition is true, then the method 100 moves to operation 140. If this condition is false, then the method 100 moves to operation 135.

In operation 135, the mobile device 16 provides on a display thereof directions to the customer to lead the customer to the location of the vehicle 12. In one example, the mobile device 16 may display the location of the vehicle 12 with respect to the location of the mobile device 16. The mobile device 16 may also provide a step-by-step navigation instructions to the customer to connect the two points (i.e., the vehicle 12 and the mobile device 16).

In operation 140, the mobile device 16 initiates transmitting the signal BLE_ADVERTISEMENT to the vehicle 12. The signal BLE_ADVERTISEMENT includes an identifier that the BLE scanner module 26 will use to identify the customer.

In operation 150, the mobile device 16 determines whether the signal BLE_SCANNER has been received from the vehicle 12. If this condition is true, then the method 100 proceeds to operation 160. If not, then the method 100 stays in operation 150.

In operation 160, the mobile device 16 acknowledges receipt of the signal BLE_SCANNER from the vehicle 12 and transmits a signal CONFIRMATION to the vehicle 12. The signal CONFIRMATION includes a confirmation number. Once the vehicle 12 receives the signal CONFIRMATION, the vehicle 12 recognizes the mobile device 16 as a trusted device.

In operation 170, the mobile device 16 can access an application loaded thereon to control various options of the vehicle 12 such as locking, unlocking and remotely starting the vehicle from the mobile device 16. The customer may download the application on the mobile device 16 at any time prior to operation 160 being executed.

FIG. 2B generally illustrates the execution of the second method 200. The vehicle 12 is generally configured to execute the operations noted in connection with the second method 200.

In operation 210, the controller 20 also establishes a first time duration that corresponds to a period of time prior to the scheduled reservation start time to monitor for the receipt of any signals from the mobile device 16 (e.g., the signal BLE_ADVERTISEMENT). In this case, the controller 20 activates the transceiver 18 to monitor for any signals from the mobile device 16. This condition minimizes power consumption for the vehicle 12 as the transceiver 18 is only active for the first time duration as opposed to strobing for any signals from the mobile device 16 continuously for lengthy periods of time. If the controller 20 determines that a present time is within the first time duration, then the method 200 proceeds to operation 220. If not, then the method 200 stays in operation 210.

In operation 220, the controller 20 wakes up the GPS unit 22 to ascertain its current GPS coordinates. The controller 20 compares its current GPS coordinates to the GPS coordinates or location data provided on the signal VEHICLE_STATUS when the reservation is made to confirm that there is a match. If this condition is true, then the method 200 moves to operation 240. If not, then the method 200 moves to operation 230. It is contemplated that the controller 20 may also include information such as fuel level and ignition status for the vehicle 12 on the signal VEHICLE_STATUS. The vehicle 12 provide fuel status (or battery charge status if the vehicle 12 is implemented as a hybrid electrical vehicle or an electric vehicle) to the server 14 to notify the server 14 of the amount of fuel or amount of battery charge that is present in the vehicle 12. The server 14 may then notify the mobile device 16 (i.e., the customer) of the amount of fuel or battery charge that is present on the vehicle 12 prior to the reservation. The vehicle 12 may also provide the ignition status to the server 14 to notify the same of either an authorized or unauthorized start.

In operation 230, the controller 20 transmits a notification to the server 14 along with its current GPS coordinates. The server 14 may then send the updated GPS coordinate data to the mobile device 16 to notify the customer.

In operation 232, the controller 20 stores the updated GPS coordinate data and associates such data as the location for which the vehicle 12 is to be picked up by the customer.

In operation 240, the controller 20 continues to scan for the signal BLE_ADVERTISEMENT from the mobile device 16.

In operation 250, the controller 20 determines whether the signal BLE_ADVERTISEMENT has been found. If this condition is true, then the method 200 moves to operation 260. If not, then the method 200 moves back to operation 240.

In operation 260, the controller 20 controls the vehicle system 30 to generate visual and audible alerts such as for example activating/deactivating exterior lighting and/or a vehicle horn. The controller 20 also transmits the signal BLE_SCANNER to the mobile device 16.

In operation 270, the controller 20 monitors for the signal CONFIRMATION from the mobile device 16 to determine if a confirmation no. corresponding to the reservation has been received. If this condition is true, then the method 200 moves to operation 280. If not, then the method 200 moves back to operation 260.

In operation 280, the controller 20 recognizes the mobile device 16 as a trusted device and the controller 20 is capable of receiving control signals from the mobile device 16 to control various aspects of the vehicle system 30 (e.g., locking, unlocking, remote start of vehicle 12, authorize use of an ignition switch via key located in the vehicle after customer gains access (or user access) to the vehicle, etc.).

The system 10 may also employ various security actions such as but not limited to: (i) only allow the mobile device 16 to operate the vehicle 12 during the confirmed duration of the rental period, (ii) utilizing an International Mobile Station Equipment Identify (IMEI) of the customer's mobile device 16 to authorize the mobile device 16 to operate the vehicle 12, (iii) further enhancing the IMEI aspect by linking the IMEI to a customer generated PIN where the customer PIN may be a standalone, (iv) requiring the customer to enter the customer's driver license number during a pairing process, and (v) verifying that the customer has a valid driver license prior to operating the vehicle (and verify customer age if desired).

While embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for reserving and accessing a vehicle, the apparatus comprising:
a transceiver; and
a controller positioned in a vehicle and being configured to:
receive a first signal indicative of a reservation time from a vehicle share server to enable user access to the vehicle; and
activate the transceiver at a predetermined time prior to the reservation time to monitor for presence of a mobile device.

2. The apparatus of claim 1 wherein the controller is further configured to receive information corresponding to a predetermined set of global positioning system (GPS) coordinates from the vehicle share server, wherein the predetermined set of GPS coordinates correspond to a location where the controller enables access to the vehicle at one of the reservation time and the predetermined time prior to the reservation time.

3. The apparatus of claim 2 wherein the controller is further configured to enable user access to the vehicle in response to the predetermined set of GPS coordinates received from the vehicle share server matching an actual set of GPS coordinates that corresponds to an actual physical location of the vehicle.

4. The apparatus of claim 3 wherein the controller is further configured to monitor for the mobile device in response to the predetermined set of GPS coordinates matching the actual set of GPS coordinates at the predetermined time prior to the reservation time.

5. The apparatus of claim 3 wherein the controller is further configured to transmit a notification to the vehicle share server in response to the predetermined set of GPS coordinates not matching the actual set of GPS coordinates.

6. The apparatus of claim 5 wherein the notification includes the actual set of GPS coordinates.

7. The apparatus of claim 1 wherein the controller is further configured to transmit information corresponding to one of an amount of fuel in the vehicle and an amount of battery charge to the vehicle share server.

8. The apparatus of claim 1 wherein the controller is further configured to: (i) receive a start time from the vehicle share server indicative of when the controller enables user access to the vehicle; and (ii) receive an end time from the vehicle share server indicative of when the controller no longer enables user access to the vehicle.

9. The apparatus of claim 1 wherein the transceiver is a Bluetooth Low Energy (BLE) based transceiver for communicating with the mobile device.

10. An apparatus for reserving and accessing a vehicle, the apparatus comprising:
a Bluetooth Low Energy (BLE) transceiver; and
a vehicle controller configured to:
receive a first signal from a server indicative of a reservation time;
activate the BLE transceiver at a predetermined time prior to the reservation time; and
enable access to the vehicle in response to detecting a mobile device using the BLE transceiver after the predetermined time.

11. The apparatus of claim 10 wherein the controller is further configured to receive information corresponding to a predetermined set of global positioning system (GPS) coordinates from the server, wherein the predetermined set of GPS coordinates correspond to a location in which the controller enables user access to the vehicle after the predetermined time.

12. The apparatus of claim 11 wherein the controller is further configured to compare the predetermined set of GPS coordinates to an actual set of GPS coordinates that corresponds to the actual physical location of the vehicle.

13. The apparatus of claim 12 wherein the controller is further configured to monitor for the mobile device in response to the predetermined set of GPS coordinates matching the actual set of GPS coordinates at the predetermined time.

14. The apparatus of claim 12 wherein the controller is further configured to transmit a notification to the server in response to the predetermined set of GPS coordinates not matching the actual set of GPS coordinates.

15. The apparatus of claim 14 wherein the notification includes the actual set of GPS coordinates as the location at which the controller enables user access to the vehicle at the reservation time.

16. The apparatus of claim 10 wherein the controller is further configured to transmit information corresponding to one of an amount of fuel in the vehicle and an amount of battery charge to the server.

17. The apparatus of claim 10 wherein the controller is further configured to receive: (i) a start time from the server indicative of when the controller enables user access to the vehicle; and (ii) an end time from the server indicative of when the controller no longer enables user access to the vehicle from the server.

18. A computer-program product embodied in a non-transitory computer readable medium that is programmed to reserve and enable access to a vehicle, the computer-program product comprising instructions to:
transmit a first signal indicative of a reservation time for a user to gain access to a vehicle to a vehicle share server; and
determine, via GPS coordinates, whether the user is approaching the vehicle at a predetermined time prior to the reservation time to gain access to the vehicle.

19. The computer-program product of claim 18 further comprising instructions to provide an electronic alert to the user to notify the user that the user is not approaching the vehicle.

20. The computer-program product of claim 18 further comprising instructions to transmit an advertisement signal to the vehicle only in response to determining that the GPS coordinates are within a predetermined distance of the vehicle.
